(19) United States
(12) Patent Application Publication
(10) Pub. No.: US 2014/0267668 A1
(43) Pub. Date: Sep. 18, 2014

(54) PORTABLE FUNDUS CAMERA

(71) Applicants: David M. KLEINMAN, Rochester, NY (US); Lumetrics, Inc., Rochester, NY (US)

(72) Inventors: Filipp V. IGNATOVICH, Rochester, NY (US); Donald S. GIBSON, West Henrietta, NY (US); Michael A. MARCUS, Honeoye Falls, NY (US); David M. KLEINMAN, Rochester, NY (US)

(21) Appl. No.: 14/211,439

(22) Filed: Mar. 14, 2014

Related U.S. Application Data
(60) Provisional application No. 61/789,570, filed on Mar. 15, 2013.

(51) Int. Cl. H04N 5/232; H04N 5/225

(52) U.S. Cl. CPC H04N 5/23212; H04N 5/2254
USPC 348/78

(57) ABSTRACT

A portable hand-held ocular fundus camera system for imaging the fundus of the eye is disclosed. The camera system is comprised of a camera housing, one or more groups of lens in an internal cavity of the housing, a front group of lenses at the front end of the internal cavity, a contact member to contact at least a portion of the cornea, a light source configured to direct light from locations inside the camera through an annulus near the periphery of the front lens group, so that the light enters the eye through an annulus at the periphery of the pupil of the eye during contact with the cornea. Light from the light source that is reflected off of the fundus that passes through the center portion of the pupil of the eye is imaged onto an imager configured to acquire a sequence of images while an actuator coupled to the imager continuously varies the location of the imager along the optical axis of the camera.

### CROSS-REFERENCE TO RELATED APPLICATIONS

This application claims priority from U.S. Provisional Patent Application No. 61/789,570 filed Mar. 15, 2013, the disclosure of which is incorporated herein by reference. Reference is also made to commonly-assigned co-pending U.S. patent application Ser. No. 13/512,336, which has a 371(c) date of Aug. 1, 2012, and which is a U.S. national stage application of PCT Application No. US2010/059000 filed Dec. 4, 2010, and entitled “PORTABLE FUNDUS CAMERA”, by Ignatovich et al., the disclosures of which are incorporated herein by reference.

### STATEMENT REGARDING FEDERALLY SPONSORED RESEARCH OR DEVELOPMENT

This invention was made with United States Government support. The U.S. Government has a paid-up license in this invention and the right under limited circumstances to require the patent owner to license others on reasonable terms as provided for by the terms of Grant No. 2R44EY020714-02A1 awarded by the National Institutes of Health.

### BACKGROUND

1. Technical Field

This invention relates generally to imaging the back of the eye, and more particularly to a fundus camera for such imaging.

2. Description of the Related Art

Vision is one of the most valued of human sensory experiences. Vision loss is an often feared untoward health event associated with serious medical, psychological, social, and financial consequences. The preservation of vision has thus been an important goal of health interventions and is recognized as such by the World Health Organization, the United States Congress, and the U.S. Centers for Disease Control.

Vision loss may be caused by many factors, stemming from damage to all parts of the visual system. Retinal and optic nerve problems have emerged as leading causes of visual loss in developed countries. These posterior segment ophthalmic conditions are major and growing causes of vision loss globally, as well. Fortunately, many of these conditions, such as neovascular age-related macular degeneration, diabetic macular edema, proliferative diabetic retinopathy, retinal detachment, and glaucoma are treatable. In most of these cases, early diagnosis and proper follow up leads to adequate maintenance of visual function for life. Visualization of the retina and optic nerve by expert clinical readers is currently required to identify these pathologic changes, and the timely initiation of interventions for these back of the eye conditions is paramount to preserving vision. Furthermore, the early diagnosis of conditions such as dry age-related macular degeneration can help patients address risk factors for progression and thereby delay and possibly prevent long term visual loss.

Generally, a retinal examination is performed by a trained clinician. The two primary methods of examining the fundus of the eye are ophthalmoscopy and table-top fundus photography. Each approach addresses only part of the problem. Indirect ophthalmoscopy (at the slit lamp or with a headset) is challenging and generally only performed by ophthalmologists and optometrists. Only patients with access to primary eye providers can benefit from these services. The instrument that allows non-eye specialists to get a glimpse of the ocular fundus is the direct ophthalmoscope (pictured at right). This device is inexpensive and widely available; however the large magnification and very small field of view combined with the fleeting nature of the images limits the value of direct ophthalmoscopes. Physicians routinely use direct ophthalmoscopes for rudimentary fundus examinations during patient visits, but such examinations rarely lead to meaningfully diagnosis, follow up conclusions, or referral unless the damage is quite advanced. Even the emerging smartphone-based imaging technology has not changed the utility of direct ophthalmoscopy. The findings of the examination are then optimally documented through fundus photography.

There are a variety of fundus cameras currently available on the market. For a summary of such cameras, one may refer to E. DeHoog and J. Schwiegerling, “Fundus camera systems: a comparative analysis,” Appl. Opt., 48, p. 221-228 (2009). For a summary of certain fundus cameras disclosed in the patent literature, one may refer to U.S. Pat. No. 7,802,884, Sep. 28, 2010, entitled “Compact Ocular Fundus Camera” by Feldon et al., the disclosure of which is incorporated herein by reference.

Bulky, expensive table-top fundus cameras are typically used to acquire high quality true-color and angiographic images of the retina with large fields of view. The operation of these table-top cameras is very elaborate, and requires a highly trained technician. A number of hand-held fundus cameras have also been developed in the past, including a contact type camera, the RetCam, sold by Clarity Medical Systems Inc. of Pleasanton, Calif., which is mainly used for infant ophthalmoscopy. These cameras, while having a smaller form-factor than the table-top devices, still lack the simplicity and portability of a device amenable to widespread distribution. The hand-held units in these cameras are bulky and are attached to a base-station via a thick cable. Alignment and focusing of the cameras is not intuitive, and in some versions the size of the field of view is inadequate. In addition, these cameras do not provide a significant reduction in cost, while lacking the imaging quality of the table-top cameras.

Other compact handheld camera systems found in the patent literature include the following: U.S. Pat. No. 5,822,036 issued Oct. 13, 1998 and entitled “Eye Imaging Unit Having a Circular Light Guide” by N. A. Massie and W. Su discloses a portable eye image capture unit having a circular light guide positioned adjacent to and behind a corneal contact lens. U.S. Pat. No. 7,954,949 issued Jun. 7, 2011 and entitled “Hand-Held Ocular Fundus Imaging Apparatus” by T. Suzuki discloses an ocular fundus imaging apparatus in which alignment is performed by holding a hand grip and securing a face pad against part of the face of a patient. U.S. Patent Application No. 2012/0229617 published Sep. 13, 2012 and entitled “Hand-Held Portable Fundus Camera for Screening Photography” by N. A. Massie and W. Su discloses the modification and integration of an existing consumer digital camera to enable point and shoot fundus photography of the eye using the camera's autofocus capability. U.S. Patent Application No. 2013/0057828 published Mar. 7, 2013 and entitled “Handheld Portable Fundus Imaging System and Method” by M. deSmet discloses a system and method for fundus imaging wherein multiple images are combined using selective illumination of different sectors of the field of view of the fundus using off-axis illumination. U.S. Patent Application No. 2008/0002152 published Jan. 3, 2008 and entitled “Hand Held Device and Methods for Examining a Patients Retina” by W. J. Collins discloses a handheld device for examining a patient's retina in which illuminating light beams are polarized as they are directed toward the patient's retina.

At this time, fundus photographic systems are typically available only in high-end, high-overhead technology dominated ophthalmic and optometric medical practices. Not all patients who could benefit from retinal fundus photography have access to it, even if they have a primary eye care provider. Likewise, those patients that rely on general practitioners, family practice physicians, internists, and pediatricians for ophthalmic health concerns have essentially no access to comprehensive retinal imaging. Moreover, special populations, including residents of nursing homes, assisted living facilities or group homes, prisoners, remote populations such as Native Americans on reservations and people residing in very rural communities have restricted access to a comprehensive and well documented fundus evaluation, and fundus imaging. The problem is even more severe in developing nations, and also in many Western countries where expensive heath care technology is more controlled, such as by government mandate.

Early detection and therapy of early eye diseases results in better vision for elderly patients. There has thus been increasing emphasis on ophthalmic imaging technologies as standards of care. Existing fundus cameras are expensive (e.g., $20,000 to $45,000 or more), require considerable technical expertise to operate, and are not easily portable. As a result, fundus photography as a screening tool has been implemented only to a very limited extent. The widespread implementation of fundus photography and usage in remote areas has so far not been practical. A low magnification, large field of view, user friendly, portable, cheap, and durable, fundus camera would be extremely beneficial in helping reduce rates of blindness. The benefits of a new method of photographic documentation of a patient's retina would be cost effectively expanded to large populations, thereby allowing for expert diagnosis, appropriate follow up, and optimal management to reach at-risk patients in all areas of our nation and the world. The adaptation of this technology will improve patient care in many scenarios.

In summary, there is therefore a need for a hand-held, durable, portable, and easy-to-use digital fundus low-cost camera, having an adequate field of view which can significantly improve patients' access to the high quality fundus images required to manage retinal and optic nerve diseases. The portability and versatility of such a device would enable the implementation of retinal imaging in large populations that previously did not have easy access to such technology.

### SUMMARY

The present invention meets this need by providing a compact portable fundus camera device. The camera can be used by individuals of varying backgrounds. For example, a retina specialist might utilize one such device in each exam lane to speed patient flow; optometrists or general ophthalmologists might find the device economically most favorable as the only mode of photographic documentation of the fundus in their practices; and a primary care provider might use it to document and follow childhood diabetics and patients with other conditions that affect the eyes. The camera enables a user to obtain one or more digital images of the fundus of a patient, deliver such images electronically to an expert reader of such images, and consult with the expert for advice as needed. Health aides, technicians, or nurses may be trained to use the camera to obtain retinal photographs of under-served populations.

In these settings, the images may be stored and digitally transmitted to qualified image readers to determine the need for further patient observation and/or referral to other medical specialists. The camera is compatible with mobile computing and image viewing platforms (such as tablet PCs, smartphones, hybrid notebooks, etc.) and can be easily integrated into the growing and dynamic field of remote health monitoring. In so doing, the camera can play an important role in helping improve the quality of medical outreach programs as well as reduce rates of blindness and visual disability worldwide.

Additionally, the camera particularly benefits a growing segment of our populace, the aging population. The instant camera device has utility for population-based screening for potentially blinding retinal and optic nerve diseases, with the potential for significant health and direct and indirect medical cost savings in the geriatric population.

In various embodiments of the present invention, there are provided modifications and improvements in imaging the fundus, using the camera system, which is portable. In certain embodiments, aspects of the invention include lenses, methods of focusing, illumination systems, lens configurations, and compatibility with hand held computing and/or imaging platforms. In another aspect, reusable or disposable covers are provided for making contact with the cornea of the eye and for antisepsis and protection of the innovative camera described herein. The contact member may be further comprised of a protective cover removably joined to the forward housing end and in contact with the forward lens. The cover may be comprised of a central lens in contact with the forward lens. The forward lens may have an exterior surface having a curvature to render it contiguously contactable with the cornea of the eye. The forward lens may be suspended in the housing on a cushioning mount and may be rearwardly displaceable by contact with the eye. The camera may include a sensor that detects the contact with the eye. The camera also includes optics configured to focus light reflected back from the fundus onto an imager. In some embodiments, the optics may be capable of varying the field of view among different portions of the fundus. The camera also contains processing electronics, which are capable of assessing the quality of a captured image, such as the sharpness, brightness, contrast, saturation, and other metrics. The processing electronics may also be capable of finding various retinal features in the picture, such as the optic nerve, blood vessels, macula and other features.

In certain embodiments, the weight distribution of the camera allows for balanced positioning of the camera housing onto a hand. The user holds the camera similar to how a person holds a pencil. The weight distribution allows the camera to rest on the first dorsal interroseus muscle without the need to hold it with any fingers.

The camera may also contain a mechanism to adjust the position of lenses or of the imaging sensor, for the purpose of achieving sharp focus imaging. The motion of the elements may be accomplished using piezo-motors, micro-steppers, voice coils, and/or rotating mechanisms combined with fine or coarse threads, which allow the elements to move along the optical axis of the camera. In a preferred embodiment, when contact is made with the cornea of the eye, a sequence of multiple images are taken, each with a different degree of focus at the image sensor plane while moving the lenses or the image sensor. The processing electronics are configured to analyze the sequence of images and determine which image is in best focus.

The illumination source inside the camera may be comprised of a multitude of white or color LEDs, lasers or other light sources. The light sources may be coupled into optical fiber, with the output of the optical fiber forming the illumination source for the camera. The relative intensity of the multicolor sources may be changed to generate illumination of different colors. The light sources may be turned on and off by synchronizing the sources with the camera image acquisition, focusing motor motion, and other triggering events. The emission cone angle of the illumination source may be shaped using micro-optical elements, curved mirrors, slits, or combinations thereof.

Also disclosed in this invention is the utilization of hand held imaging and communication device technology platforms with a battery powered hand-held fundus camera. The camera may communicate to a personal digital assistant system via wireless communication (e.g. Bluetooth®) or a cable, and the retinal image may be viewed in real time in a portable manner. The retinal images may be saved directly on the hand held imaging platform, or in software embedded in the fundus camera itself.

The camera may also contain one or several multi-function buttons, which control the camera based on the duration and the number of times the buttons are engaged within a certain period of time.

The camera may also contain position sensors, which allow for the software to record the orientation of the camera during the acquisition of an image. The image may then be digitally corrected based on the position information of the camera.

The fundus camera may also include the capability of taking a photograph of the patient's name, or image of the patient, or any other identification (barcode or insurance card, etc.). Such a method ensures that a retinal photograph is always associated with the patient's identity.

In a first embodiment of the invention, a fundus camera, for imaging at least a portion of a fundus of an eye is provided. The camera comprises a camera housing forming an internal cavity having front and rear ends. The camera also comprises a front group of lenses disposed in the front end of the internal cavity and aligned on a central axis defining an optical axis of the camera. The camera further comprises a contact member which is substantially transmissive of light positioned at the front end of the front group of lenses. A portion of the contact member is configured to contact at least a portion of a cornea of the eye. The camera system also comprises a light source and an imager. The light source is configured to direct light from locations inside the camera through an annulus near the periphery of the front lens group. When in contact with the eye, light from the light source enters the eye through an annulus at the periphery of the pupil of the eye. The imager is located at the rear end of the internal cavity and the imager is configured to acquire a sequence of images from a portion of the fundus of the eye illuminated with light from the light source, which is reflected by the fundus and transmitted back through the center portion of the pupil of the eye. The camera system further comprises an actuator which is coupled to the imager and the camera housing for continuously varying the location of the imager along the optical axis of the camera.

In accordance with the invention, a method for imaging at least a portion of a fundus of an eye is also provided. The method comprises providing a compact hand held camera comprising a camera housing forming an internal cavity having front and rear ends, a front group of lenses disposed in the front end of the internal cavity and aligned on a central axis defining an optical axis of the camera and a contact member substantially transmissive of light positioned at a front end of the front group of lenses with a portion of the contact member configured to contact at least a portion of a cornea of the eye. The provided camera also comprises a light source configured to direct light from locations inside the camera through an annulus near the periphery of the front lens group and when the contact member is in contact with the eye, light from the light source enters the eye through an annulus at the periphery of the pupil of the eye. The camera also comprises an imager located at the rear end of the internal cavity. The imager is configured to acquire a sequence of images from the portion of the fundus of the eye illuminated with light from the light source, which is reflected by the fundus and transmitted back through the center portion of the pupil of the eye. The camera also comprises an actuator coupled to the imager and the camera housing operable to continuously vary the location of the imager along the optical axis of the camera and a contact sensor for triggering image acquisition of the sequence of images upon contact of the contact member with the cornea of the eye.

The method further includes turning on the actuator to continuously vary the location of the imager along the optical axis of the camera, turning on the light source, contacting the cornea of the eye with the contact member and triggering the contact sensor, and acquiring or collecting a sequence of images at different imager locations along the optical axis of the camera in response to the contact sensor trigger signal.

These and other aspects, objects, features and advantages of the present invention will be more clearly understood and appreciated from a review of the following detailed description of the preferred embodiments and appended claims, and by reference to the accompanying drawings.

### BRIEF DESCRIPTION OF THE DRAWINGS

The present disclosure will be provided with reference to the following drawings, in which like numerals refer to like elements, and in which:

FIG. 1 is a schematic diagram of the fundus camera of the present invention showing a cross-sectional view through the center of the camera body;

FIG. 1A shows a schematic of the optical path of the light reflecting off of the retina of a patient and traveling through the fundus camera optics to form an image on the imager;

FIGS. 2A and 2B show top and side elevation views of a first ergonomic shape of an embodiment of a fundus camera of the present invention;

FIGS. 2C and 2D show top and side elevation views of a second ergonomic shape of an embodiment of a fundus camera of the present invention;

FIG. 3 is a schematic diagram of the illumination path of light sources passing through the camera optics and reaching the retina of a patient;

FIG. 3A shows a schematic of an LED or laser illumination circuit board that emits light, which follows the illumination path shown in FIG. 3;

FIG. 3B is a schematic diagram of a fiber coupled LED or laser illumination ring that emits light, which follows the illumination path shown in FIG. 3;

FIG. 4 shows an expanded view of an embodiment for coupling the light being emitted by the LED or lasers into an illumination lens of the fundus camera;

FIG. 5A-5F are schematic diagrams depicting six exemplary embodiments of the attachment of a disposable plastic tip to the fundus camera, as well as an expanded view of the camera-eye interface region;

FIG. 6 depicts one embodiment of a prototype of the fundus camera, and how it may be assembled; and

FIG. 7 is a flow chart showing the steps performed in carrying out an embodiment of this invention.

The present invention will be described in connection with preferred embodiments, however, it will be understood that there is no intent to limit the invention to the embodiments described. On the contrary, the intent is to cover all alternatives, modifications, and equivalents as may be included within the spirit and scope of the invention as defined by this specification, drawings and appended claims.

### DETAILED DESCRIPTION

The present description is directed in particular to elements forming part of, or cooperating more directly with, apparatus, systems and methods in accordance with the invention. For a general understanding of the present invention, reference is made to the drawings. It is to be understood that elements not specifically shown or described may take various forms well known to those skilled in the art. Figures shown and described herein are provided in order to illustrate key principles of operation of the present invention and are not drawn with intent to show actual size or scale. Some exaggeration, i.e., variation in size or scale may be necessary in order to emphasize relative spatial relationships or principles of operation.

In the drawings, like reference numerals have been used throughout to designate identical elements. The description provided herein may identify certain components with adjectives such as “top,” “upper,” “bottom,” “lower,” “left,” “right,” etc. These adjectives are provided in the context of the orientation of the drawings, which is arbitrary. The description is not to be construed as limiting the instant fundus camera to use in a particular spatial orientation. The camera may be used in orientations other than those shown and described herein.

In describing the present invention, a variety of terms are used in the description. As used herein, the term “fundus” is used with reference to the eye, and is meant to indicate the interior surface of the eye, opposite the lens, including the retina, optic disc, macula and fovea, and posterior pole.

### Overview

The retinal imaging system of the instant fundus camera utilizes multiple features in its optical design and function to provide a compact, hand-held, user-friendly camera that is capable of acquiring retinal images with sufficient quality for a physician or trained ophthalmic technician to conduct a quick and satisfactory fundus examination. The data output of the camera is compatible with storage and display on novel handheld, mobile and portable computing platforms, as well as more traditional computer systems. The software platform of the camera is compatible with medical telemetry and electronic medical records systems.

When in use on a patient, the instant fundus camera contacts the cornea and acquires at least one, and preferably a plurality of images of the fundus, each image at a different focus position of the imager and in an ordered sequence. During the time interval of image acquisition, the image sensor is moved along the optical axis of the camera to acquire the sequence of images at different focal distances. The camera may also include algorithms to determine the best image quality. The camera may also contain algorithms to confirm optical alignment of the fundus in the image field of view. Once aligned, the image of the fundus may then be displayed on a mobile or portable computing platform (tablet), or on a laptop or personal computer. The data may also be stored in the camera for later examination by a trained reviewer.

### General Configuration

FIG. 1 is a schematic diagram of the fundus camera 100 of the present invention, which illustrates the general principles thereof. It is to be understood that in FIG. 1, the components of the camera are illustrated schematically, and may not be to scale. The camera 100 is operated as a hand-held instrument, comprising a camera exterior housing 113 that may be shaped as a cylinder or any other form that is convenient for easy manipulation. The inside of the camera housing 113 comprises an internal cavity 118 for mounting the various components of the camera 100. The camera 100 is further comprised of one or more groups of lenses disposed in the internal cavity 118 of the housing 113. The central axis (center line) of the one or more groups of lenses defines the optical axis of the camera 100 shown by dashed line 122 in FIG. 1. The one or more groups of lenses include a front lens group 104 at the front end of the camera housing 113, an intermediate lens group 105, an illumination lens group 107, and an imaging lens group 109 disposed sequentially in the internal cavity 118 of the housing 113. A contact member 201 is positioned at the front end of the front group of lenses 104. The contact member 201 is made of a material that is substantially transmissive of light and it is shaped so that it contacts at least a portion of the cornea of the eye 103 when brought into contact with the eye 103.

The fundus camera 100 further comprises a front end housing 505, an intermediate housing 402 and a back end housing 408 contained within exterior housing 113. The front end housing 505 (see also FIGS. 5A-5F) has a cavity and holds the front lens group 104 in place. The intermediate housing 402 holds the intermediate lens group 105 in place and the back end housing 408 holds the illumination and imaging lens groups 107 and 109 in place. The front end, intermediate and back end housings 505, 402, and 408 are designed and slotted to fit into each other so that the optical axis of all of the lens groups are co-aligned with each other and collinear with camera optical axis 122 when assembled in the camera exterior housing 113.

The fundus camera 100 also comprises a light source 116 shown as an illumination ring in FIG. 1. The light source 116 is configured to direct light from locations inside the camera 100 through an annulus near the periphery of the front lens group 104, so that light from the light source 116 enters the eye 103 through an annulus at the periphery of the dilated or non-dilated pupil of the eye 103 when the contact member 201 is in contact with the eye 103. The light from the illumination ring light source 116 is delivered to an illumination aperture 108 directly, or through an aperture, or mirrors, or microlenses, or optical fiber, or a combination of thereof surrounding the imaging lens group 109. Light passing through the illumination aperture 108 passes through the perimeter of illumination lens group 107, then through the intermediate lens group 105 and the front lens group 104 where the light is delivered to the cornea-lens interface for fundus imaging.

The illumination light enters the eye 103 through an annulus at the periphery of the non-dilated pupil 102 (FIG. 3), while the imaging is relayed through the central portion 102C of the pupil (FIG. 1A). Such an approach helps to avoid image deterioration due to reflections and scatter off the surfaces and volumes of the cornea and crystalline lens inside the eye 103. Further details of the illumination path are shown in FIG. 3 and are described later herein.

The fundus camera 100 further comprises an imager 112, located at the rear end of the internal cavity, coupled to an actuator 111. The imager 112 array is preferably a CCD or CMOS image array with a sufficient number of pixels (preferably a minimum of 640 by 640 pixels) to obtain a high resolution image of the fundus. The imager 112 images incoming light onto the image plane of the imager 112. The imager 112 is configured to acquire a sequence of images from the portion of the fundus of the eye 103 illuminated with light from the light source 119, which is reflected by the fundus and is transmitted back through the center portion 102C of the pupil 102 of the eye 103. During operation of the camera 100, the actuator 111 continuously varies the location of the imager 112 along the optical axis 122 of the camera 100, which varies the location of the image plane of the imager 112 by the same amount.

The actuator 111 may be comprised of a piezoelectric motor, an electrostrictive motor, a micro-stepper, one or more voice coils, or other suitable devices, and may be coupled to a rotating mechanism (not shown) combined with the fine or coarse threads such as a rotating shaft linear slide (not shown), which enable the elements to move along the optical axis 122 of the camera 100. A suitable piezoelectric motor is the M3 or SQUIGGLE® motor, manufactured by New Scale Technologies, Inc. of Victor N.Y. The actuator 111 may continuously vary the location of the image plane of the imager 112 between a close image plane position 124 and a far image plane position 126 shown as dotted lines in FIG. 1. Alternatively, the focal position of the imager 112 may be adjusted by adjusting the location of the imaging lens group 109 along the optical axis 122 of the fundus camera 100 and keeping the imager 112 at the same focal plane.

in certain embodiments, the actuator 111 functions by monotonically increasing the location of the image plane from close image plane position 124 to far image plane position 126 over a time interval t₁ followed by monotonically decreasing location of the image plane position from far image plane position 126 to close image plane position 124 over a time interval t₂. This process for cycling between the two distance limits may be repeated continuously while the camera 100 is being operated. The locations of the close image plane position 124 and the far image plane position 126 are determined by the optics of the camera 100 as described below so that a well-focused fundus image in a large majority of human subjects will occur within the range of the close and far image plane positions 124 and 126 of the image plane of the imager 112.

There is a large variation in eye structure and corneal and lens conformations among different individuals. Thus, individual eyes will not usually come to a focus in the same plane from one eye to the next. When light from the fundus camera 100 passing through the pupil is incident on the fundus region of the retina 101, the light that is reflected by the fundus passes through the fundus camera optics and comes to a focus at a focal plane. In order to get a well-focused image, the imager plane of the imager 112 must be located at the focal plane of the light reflected off of the fundus region of the eye 103 being measured. Thus, there is a need to match the focal position of the imager 112 with the location of the focal plane of the light reflected off of the fundus for each individual's eye.

Since the focus properties of an individual's eyes are not known, the fundus camera 100 of the present invention utilizes the method of obtaining multiple images while adjusting the location of the imager plane to ensure that at least one image is in sharp focus. The camera 100 contains a mechanism to adjust the position of lenses or of the imaging sensor 112, for the purpose of achieving the sharp focus imaging.

When using the fundus camera 100 to acquire fundus images, the contact member 201 at the front end of the front lens group 104 is brought into contact with the cornea of the eye 103 while being centered on the pupil 102 of the eye 103. The contact member 201 also comprises a proximity or contact sensor 117, which is used to trigger the image acquisition processes within the camera 100. Upon contact with the cornea of the eye 103, the contact sensor 117 initiates the acquisition of a sequence of images obtained while the imager 112 is being continuously moved along the optical axis 122 of the camera 100. The contact sensor 117 may be electrical, wherein the contact with the eye 103 results in closing a contact between two electrodes (not shown). The contact sensor 117 may also be a pressure sensor, optical sensor, capacitive sensor, piezoelectric, electrostrictive, piezoresistive strain gauge, electromagnetic, or potentiometric sensor, or a sensor based on automatic image recognition using the camera's optics and the imaging array 112.

Once in contact with the cornea, the camera 100 communicates (such as via sound or lights) with the operator, and initiates the capture of images. The camera 100 digitally records an image or multiple images of the fundus, while the actuator 111 is moving the imaging sensor though the multitude of positions. Since the contact sensor 117 initiates the acquisition of a sequence of images obtained while the imager 112 is being continuously moved along the optical axis 122 of the camera 100, the image plane may be located anywhere between the close image plane position 124 and the far image plane position 126 when data acquisition is initiated.

In order to ensure that there will be at least one well-focused image obtained while the imager 112 is being moved, the image capture period is preferably a minimum time interval of t₁+t₂. The frame rate of the camera 100 and the time interval for capture determine the number of images in the sequence of images that are acquired. The speed of the actuator 111 together with the frame rate of the camera determines the focus difference between adjacent acquired image frames.

For a fundus camera 100 operating at a frame rate of 30 Hz, the acquisition period should be 1 second or longer to ensure that there is at least one image in sharp focus. In this case the time interval t₁+t₂ should be at least 1 second. In the case where t₁ and t₂ are equal to 0.5 seconds each, 15 images would be obtained during each of the monotonically increasing and decreasing distances, each successive image being approximately 1 Diopter apart in focus.

In the preferred embodiment, images are acquired at the maximum full resolution frame rate of the camera 100. Typically, sequences of 10-100 images may be acquired in 1 second. The actuator 111 is capable of adjusting the image plane of the imager 112 by a distance in excess of 400 microns and back during that time. In this embodiment, the design provides for a correction factor between −10 and +5 Diopters for the eye being tested. In other embodiments of the optical system, the correction factor may be increased to allow for fundus imaging of small children or infants, or decreased for device simplification. The speed of the actuator 111 may be adjusted so that the required number of images is obtained over the full adjustment distance, which at least equals the distance between the close image plane position 124 and the far image plane position 126.

In a preferred embodiment of the fundus camera 100, at least one of the acquired images is required to be within ±½ Diopter of the true focus position of the image at the imager plane. For this embodiment the image is in sharp focus when the image plane location is within ±½ Diopter of the true focus position of the image. In order to ensure that at least one image is within ±½ Diopter (D) of the true focus, a maximum of 1.0 Diopter difference in focus may occur between successive images.

In a preferred embodiment, the duty cycle of the time intervals t1 and t2 may be altered so that more images are obtained in one direction than the other while the imager plane is being adjusted. For example, in the case where t₁=0.9 seconds and t₂=0.1 second there would be 27 images acquired during time interval t₁ while the image plane of the imager 112 is being monotonically increased from the close image plane position 124 to the far image plane position 126, and only 3 images obtained during the time interval t₂. For this case, the successive images would be 0.556 D apart in focus for the images recorded while the image plane location is being monotonically increased. Thus, changing the duty cycle of t₁ and t₂ away from 50% results in smaller focus differences between adjacent images obtained when the imager 112 is being moved in one direction along the camera axis 122 as compared to the 50% duty cycle case. This may result in multiple adjacent images to be in sharp focus. In the case where t₁=0.9 seconds and t₂=0.1 second, there will be a minimum of 2 or 3 successive images that are in sharp focus.

The camera 100 may also optionally include electronics which enable it to acquire images while the actuator 111 is moving in only one direction, such as during the intervals in which the image plane location is being monotonically increased only. For the 50% duty cycle case this results in the analysis of half of the number of images, and for the 90% duty cycle case, results in a 10% reduction in the number of images to be analyzed.

Referring back to FIG. 1, the camera's optics images the retina onto imager 112, which is attached to the actuator 111 for focusing purposes. Module 114 located at the back end of the camera housing contains electronics, electronic interfaces and a battery. The acquired images are analyzed for completeness with regard to target field of view requirements, and the camera 100 communicates to the user when the image quality is deemed to be acceptable by the camera electronics 114 and software. After the image acquisition is complete, the image(s) may be transmitted wirelessly (e.g., via a “Bluetooth®” communication) or transmitted through a connector cable (not shown) to a nearby personal computer (not shown) or a portable imaging system (not shown) for viewing and storage. Additionally, a copy of the image may be stored in the on-board memory of the camera 100, so that it can later be transferred to a computer via a USB or other fast connection.

The fundus camera 100 may also include an accelerometer or orientation sensor (not shown) to know the orientation, including level and inclination, of the fundus camera 100 during image acquisition. Its function is to help align the camera 100 with respect to the macula region of the retina. The camera 100 may also include a level indicator or display or an array of LED lights (not shown) to indicate orientation.

The fundus camera 100 may also include a button 115 (see FIGS. 2A and 2B) which may function to arm the system, i.e., place it in a state of readiness. It may be used to turn the focusing actuator 111 on or off, or the illumination system 116 on and off, and to take a single snapshot. It may also be used to start and stop the focusing motors, or to trigger or stop image acquisition or start or stop image processing. The button 115 may have different functionality depending on how long it is depressed or based on the number of presses. For example, two consecutive clicks of the button may trigger a single frame acquisition; depressing the button for 3 seconds may turn on the illumination, and consecutive additional clicks of the button may erase the images acquired from the last patient; holding the button for 20 seconds may format the memory within the camera; and so on.

### Imaging Optical Design

FIG. 1A depicts the optical configuration of one embodiment of the fundus camera 100. It is to be understood that the dimensions and configuration of the optics thereof are to be considered exemplary and not limiting. The design and ray simulation was conducted using ZEMAX® optical design software produced and sold by the Zemax Development Corporation of Bellevue, Wash. The scattered light from retina 101 is collected through the eye pupil 102 by the contact member 201 (see FIG. 1) of the front lens group 104. In this embodiment of the fundus camera 100, the diameter of the contact area of contact member 201 is 5.5 mm, while the diameter of the pupil 102 is 2 mm. The imaging pupil is 1 mm, while the illumination ring at the pupil plane is between 1 and 2 mm. The light is then relayed to the imager 112 though the intermediate lens group 105, intermediate image plane 106, the illumination lens group 107 and the imaging lens group 109. Overall system length, from the contact surface of the front lens group 104 to the imaging array 112 is 127 mm. With changes in lens size and power in alternative embodiments, this length may change.

The contact geometry of the contact member 201 effectively eliminates the refractive power of the cornea, and thus allows the optical designer to choose the appropriate f/# of the optical system to image the retina 101 through the pupil 102. The optical system of the camera 100 is designed for a 40 degree full field of view (FOV), which is comparable to most of the commercial table-top fundus camera instruments currently available on the market. Referring again to FIG. 1A, the full field of view is illustrated by the fans of rays 119 originating at the retinal surface 101. In the imaging of a typical eye 103, such a FOV corresponds to a circle of approximately 12.5 mm in diameter.

One embodiment of the fundus camera 100 contains the optical elements shown in TABLE 1. The intermediate image is formed between lens groups 105 and 107. The intermediate image is then imaged onto the imager by groups 107 and 109. The groups 104, 105 and 107 also form the optical train to deliver the illumination light from the illumination surface 108 onto the retina 101, and form a uniformly illuminated field.

TABLE 1
Lenses used in the ZEMAX model shown in FIG. 1A

| Group | | | |
|---|---|---|---|
| (FIG. 1A) | Type | Thickness, mm | Diameter, mm |
| 104 | Disposable 501 | 0.2 | 5.5 |
| 104 | Spherical glass | 1.8 | 6.32 |
| 104 | Aspheric glass | 3.0 | 7.272 |
| 105 | Aspheric glass | 5.0 | 10.450 |
| 105 | Spherical glass | 1.008 | 9.446 |
| 107 | Spherical glass | 2.0 | 9.72 |
| 107 | Spherical glass | 3.0 | 9.498 |
| 109 | Spherical glass | 4.0 | 4.344 |
| 109 | Spherical glass | 4.0 | 3.782 |
| 109 | Spherical glass | 2.5 | 4.408 |

Different individuals may require different levels of illumination in order to acquire acceptable quality fundus images. The retina and optic nerve may reflect light differently depending on race, ethnicity, pigmentation, pathology or other reasons. Thus, the same amount of illumination may not be acceptable for all subjects. Some embodiments of the fundus camera 100 may incorporate an automated illumination control sensor to automatically adjust the power level supplied to the light source 116. In other embodiments, the light source power may be adjusted externally by the user based on the subject's pigmentation (i.e. high illumination for highly pigmented eyes, lowest for least pigmented, most reflective, as pigment absorbs light). There may be a need to adjust light source power secondarily after viewing the images, as well. In another embodiment a process method of using the camera 100 may be practiced wherein two, three, or more illumination powers may be used during image capture, with the best image being selected by an algorithm executed by the camera 100, or by an image processor external to the camera 100 after the images have been transferred to the external processor. Another method may rely on software and hardware within the imager 112 (i.e. CCD, CMOS, or other) to adjust the illumination based on a sensor-perceived variable, such as brightness or whiteness of the optic nerve. In summary, illumination level effects on image quality may be addressed within the camera system by a number of approaches and may be implemented by various embodiments of the present invention.

### Disposable Insert Contact Member

In some embodiments, the contact member 201 may be comprised of a disposable insert. As shown in FIG. 5A, a disposable transparent contact lens insert 501 covers the front of the front glass lens 504 of front lens group 104. The thickness of the disposable insert 501 at the optical axis 122 may be approximately 200 microns. The disposable insert 501 is used to ensure antisepsis with a new sterile contact system for each patient, to protect the cornea from the hard glass material of the front lens 504, and to protect the front glass lens 504 of the camera from getting scratched during use.

The insert 501 may be disposed of and replaced by a fresh one after each use on a patient. The insert 501 may be made of 2-hydroxyethyl methacrylate (HEMA), hydrogels, polymethyl methacrylate (PMMA), acrylic (including hydrophilic or hydrophobic acrylics), or silicone, polyvinylidene chloride, polyethylene films, or of another suitable biocompatible polymer.

Both sides of the insert 501 may be coated with hydroxypropyl cellulose (sold commercially as Goniosol™ 2.5%, and under other brand names). The presence of the liquid between the disposable contact lens insert 501 and the eye 103, in addition to improving comfort to the patient, allows for the filling of potential gaps that exist due to the shape deviations of the actual cornea from the curvature of the contacting lens insert 501, thereby reducing optical aberrations when the camera 100 is capturing images of the fundus.

FIGS. 5A-5F are schematic diagrams depicting various approaches for attaching the disposable insert 501 to the front end of the camera 100, while minimizing the overall contact diameter of the camera 100. FIGS. 5A-D and 5F contain two views of the front of the camera 100: a side cross-sectional view (on the right side of the page), and a front view (on the left side of the page). FIG. 5E contains two side views, different by 90 degrees, in addition to the front view (shown on top right corner of the page). The contact diameter is defined as the diameter of the contact made with the cornea of the eye. In FIGS. 5A-5F, the front glass lens 504 is attached to the front end of the front end housing 505 of the fundus camera 100. The front end housing 505 holds the disposable contact lens insert 501 and the front lens group 104 in place. Front glass lens 504 is the first glass lens in the front lens group 104.

FIG. 5A shows an embodiment wherein the disposable contact lens insert 501 is snapped onto the glass lens 504. The lens 504 contains an indent 502a, while the disposable contact lens 501 contains a corresponding protrusion 503a. When the contact lens insert 501 is moved into its position, the walls of the contact lens insert 510 act as a spring, pushing the protrusion 503a into the indent 502a, thereby removably engaging the insert 501 with the lens 504.

FIG. 5B shows a magnetic strip 503b embedded into the front surface of the front end housing 505. At the same time, a corresponding strip of magnetic material 502b (e.g. iron) is embedded into the edges of the contact lens 501. When the magnetic strip 503b and the iron strip 502b come into close proximity, the disposable lens 501 is held in place by the magnetic force between them.

FIG. 5C demonstrates a vacuum mechanism for attaching the contact lens insert 501. The back surface 502c of the contact lens insert 501 contains a slight indent curvature. When the contact lens insert 501 is pushed against the flat front surface of the glass lens 504, the air between the contact lens insert 501 and the glass lens 504 is expelled. Upon the release, the created vacuum in the volume between the contact lens insert 501 and the glass lens 504 holds the contact lens insert 501 firmly attached to the glass lens 504, and therefore prevents ambient air from returning to this volume.

FIG. 5D shows another attachment mechanism, wherein the edge of the contact lens insert 501 has a slightly larger thickness than an opening underneath a beveled ledge 502d of the lens housing 505. Upon attaching the contact lens insert 501, the edge of the lens is squeezed and pushed under the ledge 502d, where it expands back to its original shape, and holds the contact lens insert 501 in its place.

The front contact lens 501 in FIG. 5E contains ledge protrusions 502e that fit through corresponding locking openings (503e) of similar size in the ledge on the front of the housing 505. When the ledge protrusions 502e are fit through the openings 503e, the contact lens insert is then twisted counterclockwise or clockwise. The space underneath housing ledge has a slight bevel, which pushes the protrusions 502e and the contact lens insert 501 against the glass lens 504.

The back surface of the back edge 502f of the contact lens 501 in FIG. 5F includes a non-permanent adhesive, which attaches to the mating surface of the front tip housing and holds the contact lens insert 501 in place. The back surface of the back edge 502f of the contact lens insert 501 in FIG. 5F is made to tightly co-act or intertwine with the mating surface of the front tip housing, and friction holds the contact lens insert 501 in place. The non-permanent adhesive may be made of an adhesive material, or a mechanical engagement material such as Velcro®.

### Illumination Design

FIG. 3 is a schematic diagram of the illumination path of the light emanating from the illumination ring light source 116 as it passes through the fundus camera optics and reaches the fundus region of the retina 101. In accordance with the Gullstrand principle, it is preferable that the path of the fundus illumination rays must be separated from the imaging path to prevent reflections off the cornea and crystalline lens from degrading the image to be acquired. The illumination system 116 is designed so that light enters the eye 103 through an annulus at the periphery of the non-dilated pupil 102 (FIG. 3), while the imaging is relayed through the central portion 102C of the pupil (FIG. 1B). Such an approach helps to avoid image deterioration due to reflections and scatter off the surfaces and volumes of the cornea and crystalline lens inside the eye.

The illumination path in FIG. 3 is shown traveling from right to left with illumination light rays 130 indicating the paths of individual rays of light. In the instant fundus camera design, the illumination is shown as emanating from the illumination aperture 108 on the right side of the diagram. The illumination aperture 108 comprises a ring of light surrounding the imaging lens group 109.

Break line 120 indicates that part of the optical path has been omitted from the schematic diagram shown in FIG. 3. The break line 120 is located between the intermediate image plane 106 and the illumination lens group 107.

The light passing through the illumination aperture 108 first passes through the perimeter of the lenses in the illumination lens group 107, is then focused at the intermediate image plane 106, passes through the intermediate lens group 105 and focused by the front lens group 104 to pass through the periphery of the eye pupil 102 and illuminate the fundus region of the retina 101 of the eye 103. The illumination optics is designed so that the field of view illuminating the fundus region of the retina is a minimum of ±20°.

Further details of the light source 116 and the illumination path to the illumination aperture 108 are shown in FIG. 3A, FIG. 3B and FIG. 4. The light source 116 may be comprised of multitude of white or color LEDs, lasers or other light sources 301a, 302a and 303a. The fiber coupled light source 307b is coupled into optical fiber or optical fiber bundle 302b, and the output of the optical fiber at the optical fiber tip 304b form the illumination source for the camera 100. The relative intensity of the multicolor sources may be changed to generate illumination of different colors. The light sources may be turned on and off by synchronizing the sources with the camera frames acquisition, focusing motor motion and other triggering events including triggering by the contact sensor. The emission cone angle of the illumination source may also be shaped using micro-optical elements, curved mirrors, slits, or any combination of thereof.

FIG. 3A is a schematic diagram of an LED or laser illumination board 300 which has a ring of illumination sources which emit light and follows the illumination path shown in FIG. 3. The illumination board 300 is preferably comprised of a circuit board 305 with multiple chip-based light sources 301a, 302a and 303a mounted in an illumination ring 116 surrounding hole 304a, together with drive electronics which control the timing and relative output power of each of the light sources 301a-303a. The hole 304a in circuit board 305 is approximately centered in the circuit board 305 so that the imager lens group 109 may be inserted into the hole 304a. The light sources 301a, 302a and 303a may be white LEDs, multicolor LEDs or multicolor laser diodes. In a preferred embodiment, the light sources 301a, 302a and 303a are red, green and blue surface mounted chip LEDs, respectively, such as Kingbright 1.6×0.8 mm SMD CHIP LED Lamps.

FIG. 3B is a schematic diagram of a fiber coupled LED or laser illumination ring light source 307b which emits light that follows the illumination path shown in FIG. 3. Light is emitted by the fiber-coupled light sources 307b. Light sources 307b are coupled to optical fibers 302b which are terminated at the optical fiber tips 304b located in the illumination ring of the illumination aperture 108.

The light sources 307b may be located on the circuit board 305 or elsewhere on the electronics board 114 of the camera 100. A cone of light emanates from fiber tips 304b which is transmitted through the periphery of illumination lens group 107 and then follows the illumination path shown in FIG. 3. The numerical aperture (NA) of the optical fibers 302b determines the maximum cone angle that is emitted by the fiber tips 304b. The NA of the fibers 302b defines the fraction of the cornea and anterior lens surface illuminated by each terminated fiber. The fiber NA is selected so as to prevent the incident light from illuminating the parts of the cornea and lens (FIG. 1A) that are used for imaging paths.

The NA of the fibers also defines the size of the field of view of the retina 101 (FIG. 1A) illuminated in this configuration. The NA and number of illumination fibers may be adjusted to maximize image quality. Examples of fiber-coupled light sources 307b include a white light lamp, such as high intensity xenon light, white or multicolored LEDs, or multicolored lasers. The light sources may also be pulsed to produce high intensity flashes of light, synchronized with image acquisition. The pulsed source should have sufficient luminosity to produce high contrast images in a camera having a high density CCD or CMOS imager.

FIG. 4 shows an expanded view of an embodiment for coupling the light being emitted by the LED or lasers into the illumination lens group 107 of the fundus camera 100. Light source 116 is comprised of multitude of illumination sources 301a, 302a and 303a mounted in a circle to form an Illumination ring surrounding the imaging lens group 109, as described previously with reference to FIG. 3A. Light being emitted by illumination sources 301a, 302a and 303a in the illumination ring light source 116 travels to the left and is incident on mirror 403. This illumination light reflects off of mirror 403 and is caused to travel along illumination channel 405. Mirror 403 may be a plane mirror or a curved mirror. The inner surfaces of channel 405 may be composed of mirrored surfaces, or the channel may be composed of a light guide which works on the principle of total internal reflection.

The emission cone angle of the illumination light source 116 may be shaped using micro-optical elements, curved mirrors, slits, or the combination of thereof, as shown in FIG. 4. In one embodiment (not shown), a lenslet array may be formed in a ring, with each lenslet centered at the center locations of each of the individual illumination sources 301a, 302a and 303a making up the light source 116. The lenslet array may be used to collimate the light emitted from the illumination sources 301a, 302a and 303a to maximize the amount of light that travels along the illumination channel 405. Light that is transmitted along the illumination channel 405 exits at illumination aperture 108 and passes through the perimeter of the illumination lenses in lens group 107. Retainer ring 401 is used to properly position the illumination lens group 107 in the camera 100 with respect to intermediate housing 402 and the back end housing 408.

The design of the illumination system of the fundus camera 100 results in prevention of most of the effects due to scattered light from adversely affecting the image. In one embodiment, stray light that is scattered by the interfaces of the optical system and by the living tissue may be managed using stops, and/or by tilting and decentering of the optical components, and/or by configuring internal mechanical mounts and surfaces (not shown) to become baffles to absorb the stray light. Other methods to reduce light scattering are also contemplated. For example, some light may be scattered by the cornea when it enters the eye 103. Such intra-corneal and intra-lens light scattering may interfere with quality of images obtained by the camera 100. When light is scattered it scatters in all directions. Solutions to this problem include using filters, such as polarizing filters (not shown) or other optical systems (not shown) that allow light returning from only specific angles (i.e. angles consistent with retinal image formation on the CCD). In certain embodiments of the invention, polarizing filters are placed in the illumination path and imaging paths to effectively eliminate stray light due to the intra-corneal and intra-lens light scattering.

In accordance with the invention, the camera may contain processing electronics capable of assessing the image quality of each of the images in the sequence of images, using a set of predetermined image quality parameters. The set of predetermined image quality parameters includes at least one of sharpness, brightness, contrast, color hue, saturation, presence of the optic nerve, optic nerve location within the image, presence of the blood vessels, presence of the macula or any combination thereof.

In one embodiment, the first image in a test sequence is used to determine the appropriate light levels for obtaining the sequence of images. The image processing algorithm locates the optic nerve in real time and adjusts the exposure time for the rest of the images based on the light levels being reflected from the optic nerve region. The image processing electronics then locates the blood vessels in each successive image and determines their sharpness based on contrast, sharpness and MTF.

The image processing may be done internally to the camera using a Field Programmable Gate Array (FPGA) or a microprocessor. The camera may communicate to the personal digital assistant system via wireless communication (e.g. Bluetooth®) or a cable, and the retinal image may be viewed in real time in a portable manner. The retinal images may be saved directly on the hand held imaging platform, or in software embedded in the fundus camera itself. The retinal images may also be sent to a laptop or desktop computer system and be uploaded to the individual's medical records.

Furthermore, to enhance image quality, multiple images may be utilized to generate one final retinal and optic nerve image. In one embodiment, the best aspects of several photographs may be used to create a single final image for analysis by the camera user or health care provider. For example, one image may show the optic nerve best, the other the macula. The segment of the acquired image may be extracted and combined with another image (or used for enhancement) to generate a best image. Multiple images may be used in this way. Some images may contain portions having high image quality, but not over the entire anticipated field of view, and again these images may be combined for a final image using software technology that can identify landmarks and edges. In another embodiment, the best aspect of several images may be used to create a final montage. The montage may be of a mosaic nature, i.e., multiple image portions “stitched” together. The montage may look indistinguishable from a high quality image that was obtained in one frame, or it may have an appearance of placing several images from different frames next to each other. Furthermore, some images may have better contrast or light levels than others, and these images may be combined to generate an acceptable image for interpretation. In summary, the device, in some embodiments, uses more than one image to create the final imaging output or outputs of the camera for clinical interpretation.

### Ergonomic Housing

FIG. pairs 2A and 2B, and 2C and 2D show example shapes of alternative ergonomic housings 204 and 204a for the fundus camera housing 113 respectively. Two views of each of the alternative ergonomic housings are shown in the respective pairs 2A/2B and 2C/2D. FIGS. 2B and 2D are the respective vertical views of the camera housing 113, and FIGS. 2A and 2C are respective housing views rotated 90° along the optical axis of the camera. The housings shown in FIGS. 2A/2B and 2C/2D are intended for the camera to be held similarly to a pen or a marker. In certain embodiments, the length of the housing is no more than 300 mm, while the shape tapers from 25-30 mm diameter body into 5-6 mm diameter front contact member 201 as indicated by alternative housing tapers 203 and 203a shown in these figures.

The camera 100 is generally intended for use in a horizontal direction with the patient sitting up and looking straight ahead. The examiner (user) may hold the camera with the thumb and the index finger close to the contact member 201 of the camera. The thumb and index fingers may be used for fine motion control of the front of the camera, as it is brought into the contact with the eye 103.

The ergonomic housing 204 or 204a of the camera may rest on the dorsal interroseus muscle of the user, while the bottom of the front end of the camera housing near the contact member 201 may also rest on the middle finger of the same hand. The index finger or the thumb may be used to engage button 115, depending on its location. The camera may also contain additional depressions for fingers to increase comfort and guide the user to properly orient the camera 100 (e.g. ergonomic finger hold 201a). The shape of the body of the camera is intended to fit comfortably in its place on top of the dorsal portion of an adult hand.

### Camera Assembly Features

FIG. 6 shows a clam-shell type of embodiment for assembling the camera. The camera housing 113 of fundus camera 100 may be comprised of a top half-shell 608, and a bottom half-shell 609 containing lens groups 104, 105, 107 and 109, light sources 116, imager 112 and electronics 114.

The lenses and other components may be inserted into the bottom half-shell 609, and glued or fixed in other ways (e.g. using retaining rings.). The top half-shell 608 then covers the components and attaches to the bottom half-shell 609 via snapping mechanism, glue, screws or another mechanical attachment.

The housing of the camera may be machined or molded. Alternately, the optical components of the camera may be designed using plastic materials, and consecutively molded simultaneously with the housing.

Recent advances in 3D printing enable the printing of high quality optical elements. Therefore, the optical, mechanical and even electronic components may be simultaneously printed via a 3D printer.

FIG. 7 is a flow chart 700 showing the steps performed in carrying out a method embodiment of this invention. The method involves providing a compact hand held fundus camera 100 to image at least a portion of the fundus of the eye. FIG. 7 shows the steps performed in using the provided camera 100. During the first step 710 shown in FIG. 7, the operator (user) grips the camera 100 and turns on the actuator 111 which continuously adjusts the location of the image plane of the imager 112 along the optical axis of the camera 122 between the close image plane 124 and the far image plane 126.

Step 710 may be followed by Step 720 in which the light source 116 is turned on. Step 720 may then followed by step 730 in which the operator contacts the cornea of the eye centered on the pupil with the contact member 201 of the fundus camera 100. The contact member 201 may include a disposable cover at the contact region with the cornea. Alternatively, Step 710 may be followed by Step 715 indicated by the dotted arrows in which Step 720 and Step 730 are performed simultaneously. It will be apparent that the orders of Steps 710-730 may vary from that shown in FIG. 7.

Step 740 is initiated by the performance of Step 730. During Step 740 a sequence of images is acquired while the actuator 111 is changing the position of the imager 112 along the optical axis of the camera 122. Step 740 is initiated by triggering the contact sensor 117 upon contacting the cornea of the eye in Step 730.

Step 740 is followed by step 750 in which the acquired sequence of images is processed. Step 750 may be followed by Step 760 in which the image quality of the images is assessed using a defined set of predetermined image quality parameters. Alternatively the processing Step 740 and the assessment step 750 may be performed simultaneously.

Step 750 is followed by Step 760 in which one or more selected images are saved in a data file. This data file saved in Step 770 may then be added to the individual's medical record. The camera 100 may include a wireless interface for wirelessly communicating the acquired images to store remotely to the camera.

It is, therefore, apparent that there has been provided, in accordance with the present invention, a compact portable fundus camera. Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims.

### PARTS/ATTRIBUTES REFERENCE NUMERALS LIST

100 Fundus Camera
101 Fundus
102 Pupil
103 Eye
104 Front Lens Group
105 Intermediate Lens Group
106 Intermediate Image Plane
107 Illumination Lens Group
108 Illumination Aperture
109 Imaging Lens Group
110 Imager Aperture
111 Actuator
112 Imager
113 Camera Housing
114 Electronics
115 Button
116 Light source
117 Contact Sensor
118 Internal Cavity
119 Fans of Rays
120 Break Plane Indicator
122 Optical Axis
124 Close Image Plane
126 Far Image Plane
130 Illumination Light Rays
201 Contact Member
201a Ergonomic Finger Hold
203 Housing Taper
203a Alternative Housing Taper
204 Ergonomic Housing
204a Alternative Ergonomic Housing
205 Ergonomic Rounded Edge
300 Illumination Board
301a Light Source
302a Light Source
302b Optical Fiber
303a Light Source
304a Hole
304b Optical Fiber Tip
307b Fiber Coupled Light Source
401 Retaining Ring
402 Intermediate Housing
403 Mirror
405 Illumination Channel
408 Back End Housing
501 Disposable Insert
502a Indent
502b Iron Strip
502c Back surface of the contact lens
502d Beveled Ledge
502e Ledge Protrusion
502f Back Edge
503a Protrusion
503b Magnetic Strip
503e Locking Opening
504 Front Glass Lens
505 Front End Housing
608 Top half-shell
609 Bottom half-shell

We claim:

1. A fundus camera for imaging at least a portion of a fundus of an eye, the camera comprising:
a) a housing forming an internal cavity having front and rear ends,
b) a front group of lenses disposed in the front end of the internal cavity and aligned on a central axis defining an optical axis of the camera;
c) a contact member, positioned at a front end of the front group of lenses, a portion of the contact member being configured to contact at least a portion of a cornea of the eye, and wherein the contact member is substantially transmissive of light;
d) a light source configured to direct light from locations inside the camera through an annulus near the periphery of the front lens group, so that light from the light source enters the eye through an annulus at the periphery of the pupil of the eye when the contact member is in contact with the eye;
e) an imager, located at the rear end of the internal cavity, the imager being configured to acquire a sequence of images from the portion of the fundus of the eye illuminated with light from the light source, which is reflected by the fundus and transmitted back through the center portion of the pupil of the eye; and
f) an actuator coupled to the imager and the camera housing and operable to continuously vary the location of the imager along the optical axis of the camera.

2. The camera of claim 1, further comprising a contact sensor for triggering image acquisition of a sequence of images upon contact of the contact member with the cornea of the eye.

3. The camera of claim 2, further comprising a processor for assessing the image quality of each of the images in the sequence of images, using a set of predetermined image quality parameters.

4. The camera of claim 3, where the set of predetermined image quality parameters includes at least one of sharpness, brightness, contrast, color hue, saturation, presence of the optic nerve, optic nerve location within the image, presence of blood vessels, presence of the macula, or any combination thereof.

5. The camera of claim 2 where at least one of the acquired images is stored to a data file.

6. The camera of claim 1, further comprising an intermediate lens group, an illumination lens group and an imaging lens group disposed sequentially between the front lens group and the imager.

7. The camera of claim 6, wherein the light source directs light from an illumination aperture surrounding the imaging lens group through the periphery of the illumination lens group.

8. The camera of claim 2, wherein the light source is further comprised of a plurality of sources selected from white light emitting diodes, color light emitting diodes, and lasers.

9. The camera of claim 6, wherein the light passing through the illumination lens group passes through the periphery of the intermediate lens group after being focused at the periphery of an intermediate image plane located between the intermediate lens group and the illumination lens group.

10. The camera of claim 6, wherein optical fibers are coupled to the light sources to direct the light through the periphery of the illumination lens group.

11. The camera of claim 6, wherein the camera housing is comprised of a disposable cover which includes the contact member.

12. The camera of claim 8, wherein the relative intensity of the plurality of sources is variable, thereby generating illumination of different colors, and wherein the light sources are operable by synchronizing the sources with at least one of camera frames acquisition, focusing motor motion, and triggering by the contact sensor.

13. The camera of claim 8, wherein the emission cone angle of the light source is shaped using micro-optical elements, curved mirrors, slits, or combinations thereof.

14. The camera of claim 1 wherein the field of view illuminating the fundus region of the retina is a minimum of ±20°.

15. The camera of claim 1 wherein the housing has a maximum length of 300 mm and tapers from a diameter between 25 and 30 millimeters at the rear end to a diameter between 5 and 6 millimeters at the front end.

16. The camera of claim 5, further comprising a wireless communication interface and a battery for powering the fundus camera, and wherein the data file containing the acquired images is stored remotely to the camera.

17. The camera of claim 1 further comprising polarizing filters in the imaging path of the camera.

18. A method for imaging at least a portion of a fundus of an eye, the method comprising:
a. providing a compact hand held camera comprising:
i. a housing forming an internal cavity having front and rear ends;
ii. a front group of lenses disposed in the front end of the internal cavity and aligned on a central axis defining an optical axis of the camera;
iii. a contact member, positioned at a front end of the front group of lenses, a portion of the contact member being configured to contact at least a portion of a cornea of the eye, and wherein the contact member is substantially transmissive of light;
iv. a light source configured to direct light from locations inside the camera through an annulus near the periphery of the front lens group, wherein when the contact member is in contact with the eye, light from the light source enters the eye through an annulus at the periphery of the pupil of the eye;
v. an imager located at the rear end of the internal cavity, the imager being configured to acquire a sequence of images from the portion of the fundus of the eye illuminated with light from the light source, which is reflected by the fundus and transmitted back through the center portion of the pupil of the eye;
vi. an actuator coupled to the imager and the camera housing and operable to continuously vary the location of the imager along the optical axis of the camera; and
vii. a contact sensor for triggering image acquisition of the sequence of images upon contact of the contact member with the cornea of the eye;
b. turning on the actuator to continuously vary the location of the imager along the optical axis of the camera;
c. turning on the light source;
d. contacting the cornea of the eye with the contact member and triggering the contact sensor; and
e. acquiring a sequence of images at different imager locations along the optical axis of the camera in response to the contact sensor trigger signal.

19. The method of claim 18 including the steps of processing the acquired sequence of images and assessing the image quality of each of the images in the sequence of images using a set of predetermined image quality parameters.

20. The method of claim 19 where the set of predetermined image quality parameters includes at least one of sharpness, brightness, contrast, color hue, saturation, presence of the optic nerve, optic nerve location within the image, presence of the blood vessels, presence of the macula, or any combination thereof.

21. The method of claim 18, further including the step of storing at least one of the sequence of images to a data file.

22. The method of claim 21 wherein the camera includes a wireless interface, and the method further comprises wirelessly communicating the acquired images to storage remote to the camera.

23. The method of claim 18, further comprising installing a disposable cover which includes the contact member.

24. The method of claim 18, further comprising gripping the camera housing proximate to the contact member before contacting the cornea of the eye.

25. The method for imaging at least a portion of a fundus of an eye of claim 18 in which polarizing filters are placed in the imaging path of the camera.

26. The method of claim 18 where the provided camera further comprises an intermediate lens group, an illumination lens group and an imaging lens group disposed sequentially between the front lens group and the imager.
